(19) United States
(12) Patent Application Publication
(10) Pub. No.: US 2008/0179479 A1
(43) Pub. Date: Jul. 31, 2008

(54) Retaining clip for an idler assembly

(76) Inventor: Michael Petron, Alexandria, MN (US)

Correspondence Address: John M. Weyrauch;DICKE, BILLIG & CZAJA, PLLC, Suite 2250, 100 South Fifth Street, Minneapolis, MN, 55402, US

(21) Appl. No.: 11/699,677

(22) Filed: Jan. 29, 2007

(51) Int. Cl. B65G 39/12

(52) U.S. Cl. 248/309.2; 193/37

(57) ABSTRACT

An idler roller retainer clip includes a generally U-shaped member having a first end and a second opposite end, a base wall and opposing side walls extending from the base wall in a first direction. The base wall comprises an elevated tab extending from the base wall in a direction generally opposite the first direction. The side walls each comprise an edge spaced from the base wall. The edge of each side wall has a first portion, centered between the first and second ends, that is generally parallel to the base wall. Each edge further has a second portion between the first portion and the respective first and second end of the U-shaped member. The second portion of each lower edge extends at an angle from the first portion toward the base wall.

### BACKGROUND

The present invention generally relates to idler assemblies for belt conveyor equipment. More specifically, the present invention relates to a retaining clip for holding individual idler rollers of an idler assembly in their perch.

Belt conveyors are employed to transport material from one end of a conveyor to another end of the conveyor. Most belt conveyors employ a form of endless belt that is wrapped over a plurality of idler assemblies that are mounted periodically along a frame of the conveyor. One common type of idler assembly used on belt conveyors is known as a troughing idler.

A typical troughing idler 10 is shown in FIG. 1 and includes a base 12 that mounts to the frame of the conveyor. Connected to base 12 is a plurality of perch supports 14 for supporting three idler rollers 16 in a generally U-shaped configuration. As such, supports 14A located at each end of base 12 support one end of the outermost rollers 16A and 16C at a specified height above base 12, while supports 14B are positioned on base 12 to support the ends of a central roller 16B as well as an end of rollers 16A and 16C at a height below the height of supports 14A relative to base 12. Rollers 16 are typically secured to the perch supports 14, a particular necessity for road transportable folding conveyors known in the art. Folding conveyors are transported with one or more end conveyor sections folded atop a central conveyor section, thereby inverting the idler assemblies. An example of a folding conveyor is disclosed in U.S. Pat. No. 6,296,109.

Periodically, idler rollers require replacement, which entails removing a retainer holding the rollers 16 in their perch supports 14, installing a new idler roller 16, and inserting a new retainer to hold the idler roller in its perch supports. This idler roller replacement is typically performed with the conveyor belt sitting on the idler assembly. Known retainers that hold rollers 16 in perch supports 14B typically employ a folding tab that engages the perch support. Such retainers are uni-directional and can only be removed and re-installed in a single direction. Due to space constraints, known retainers are difficult to remove and reinstall.

### SUMMARY

The present invention is a retainer clip for an idler roller. The retainer clip comprises a generally U-shaped member having a first end and a second opposite end, a base wall and opposing side walls extending from the base wall in a first direction. The base wall comprises an elevated tab extending from the base wall in a direction generally opposite the first direction. The side walls each comprise an edge spaced from the base wall. The edge of each side wall has a first portion, centered between the first and second ends, which is generally parallel to the base wall. Each edge further has a second portion between the first portion and the respective first and second end of the U-shaped member. The second portion of each lower edge extends at an angle from the first portion toward the base wall.

### BRIEF DESCRIPTION OF THE DRAWINGS

FIG. 1 is a perspective view of a known troughing idler.

FIG. 2 is an enlarged partial perspective view of an idler roll assembly according to one embodiment of the present invention.

FIG. 3 is a perspective view of an idler roll retainer clip according to one embodiment of the present invention.

FIG. 4 is a side view of the retainer clip illustrated in FIG. 3.

FIG. 5 is a side view of a perch of an idler roll assembly showing an idler roll retainer clip partially inserted into the perch.

FIG. 6 is a side view of the perch of the idler roll assembly illustrated in FIG. 5 showing the idler roll retainer clip fully seated between an idler roll axel and the perch.

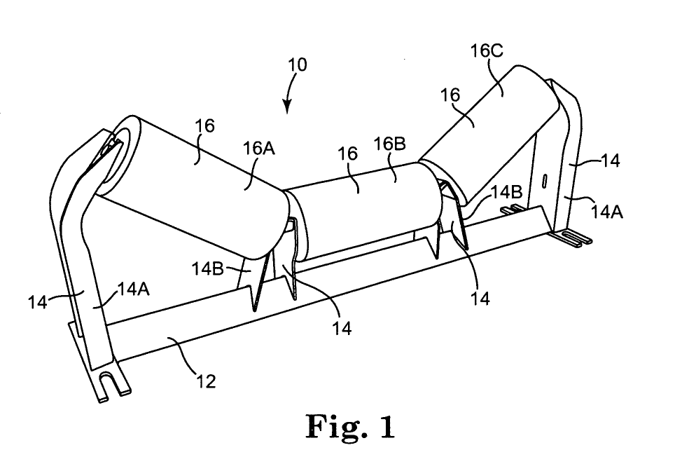

### DETAILED DESCRIPTION

The present invention provides a retaining clip for an idler assembly that is easy to install into a perch support, and can be conveniently inserted and removed from either side of the perch support.

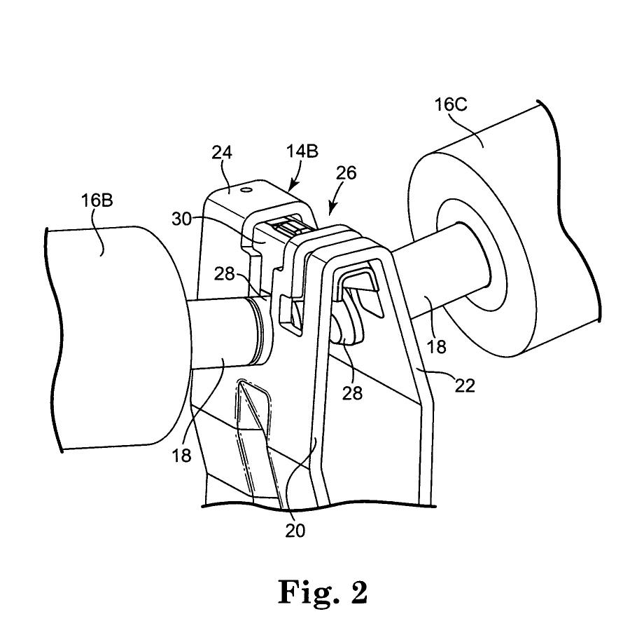

FIG. 2 is an enlarged partial perspective view of perch 14B of idler 10 supporting rollers 16B and 16C. Perch 14B is defined by generally opposed metal side walls 20 and 22, each of which are connected to a metal top wall 24. Walls 20 and 22 extend from top wall 24 at a diverging angle that is selected according to a desired troughing shape for idler 10. Walls 20, 22 and 24 are configured to define a slot 26.

Each roller 16 is carried on an axle 18, an end 28 of which is supported within the slot 26 of perch 14B. When axle 18 is positioned in slot 26, as shown in FIG. 2, the upper extent of axle 18 is spaced from top wall 24. To retain rollers 16B and 16C relative to perch 14B, a retainer clip 30 of the present invention is positioned between axles 18 and an inner surface of top wall 24. As discussed below, the configuration of retainer clip 30 permits easy insertion of clip 30 when rollers 16 are installed, and easy removal of clip 30 when rollers 16 need to be replaced on idler 10.

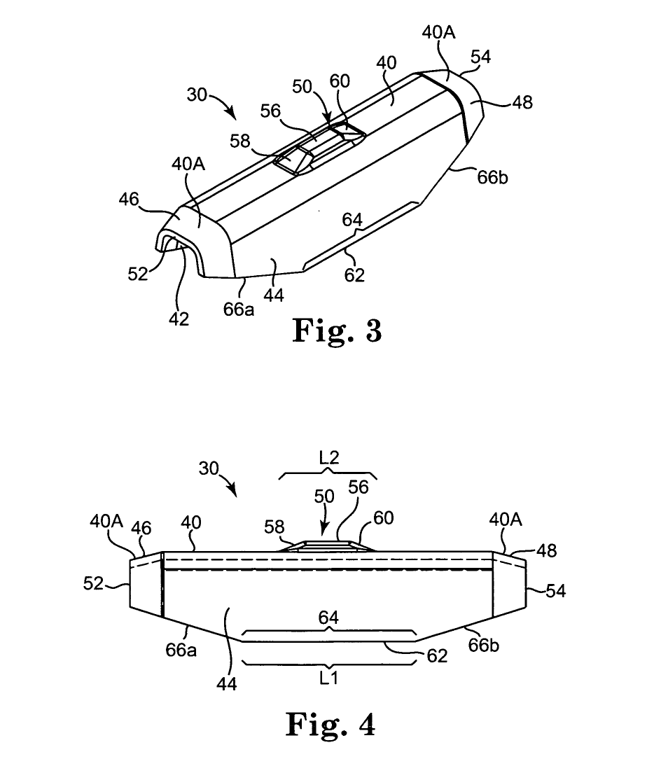

FIG. 3 is a perspective view of idler roller retainer clip 30. Retainer clip 30 is a generally U-shaped metal member formed in a stamping process. Clip 30 generally includes a top planar wall 40, opposing planar side walls 42, 44 and beveled end portions 46, 48. The top planar wall 40 includes a raised tab 50 centered on clip 30 between opposing ends 52, 54 of clip 30. The raised tab 50 is formed in the stamping process and includes a planar central portion 56 that is flanked by end ramped portions 58, 60, which are integral with wall 40.

The opposing planar side walls 42, 44 extend from top wall 40 at a diverging angle that is complimentary to the angle of side walls 20 and 22 of perch 14B. Side walls 42, 44 have a lower edge 62 that is spaced from top wall 40. A first portion 64 of lower edge 62 is generally parallel with top wall 40 and is centered on clip 30 relative to ends 52, 54. Second portions 66a, 66b of lower edge 62 extend from first portion 64 to ends 52, 54, respectively and taper at an angle from the first portion 64 toward the top planar wall 40.

Beveled end portions 46, 48 are extensions of the top planar wall 40 and planar side walls 42, 44 adjacent to ends 52, 54, respectively. A top wall 40A of beveled end portions 46, 48 extends at an angle that converges toward lower edge 62, while the side walls 42, 44 of beveled end portions 46, 48 converge toward one another. As will be discussed further herein, the beveled end portions 46, 48 are configured to facilitate the installation of clip 30 relative to perch 14B.

FIG. 4 is a side view of retainer clip 30. Raised tab 50 is integrally formed to project from top planar wall 40 such that planar central portion 56 is elevated from and offset from top planar wall 40. Ramped portions 58, 60 provide a sloped transition from top planar wall 40 to central portion 56. As shown in FIG. 4, raised tab 50 is centered relative to the first portion 64 of lower edge 62. The first portion 64 of lower edge 62 has a length L1 that is greater than length L2 of raised tab 50. It is to be appreciated that as shown in FIG. 4, clip 30 has bilateral symmetry relative to raised tab 50, such that the configuration and arrangement of beveled end portion 46 and second lower edge portion 66a is identical to beveled end portion 48 and second lower edge portion 66b. Likewise, side wall 42 is configured to be generally identical to side wall 44.

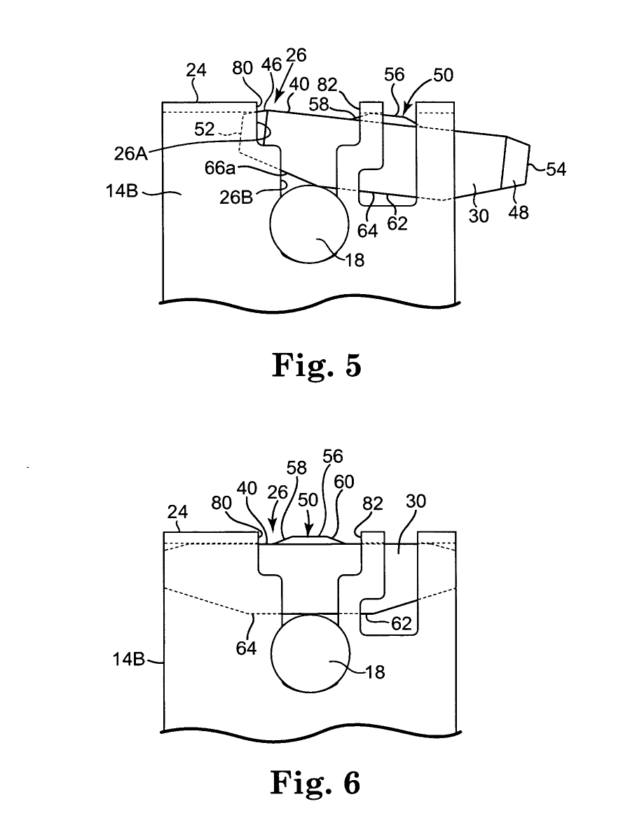

The method of installing clip 30 into perch 14B is best described by reference to the diagrammatical side view of FIG. 5. As shown in FIG. 5, slot 26 of perch 14B comprises a first portion 26A adjacent to top wall 24 defined by slot edges 80 and 82, and a second portion 26B that is spaced from top wall 24. The second portion 26B of slot 26 is narrower than the first portion 26A and is configured to support axle 18. As shown in FIG. 5, axle 18 is resting within the lower portion 26B of slot 26. Retainer clip 30 is partially inserted between axel 18 and top wall 24 of perch 14B. At this point of the installation of clip 30, the beveled end portion 46 extends beneath the top wall 24 of perch 14B adjacent to slot edge 80 when the leading edge of the first portion 64 of lower edge 62 begins to engage axle 18. At this point, the central portion 56 of the raised tab 50 is also contacting the inner surface of the top wall 24 of perch 14B. As can be seen, the taper of the second portion 66a of lower edge 62 is selected such that when the first portion 64 of lower edge 62 begins to contact axel 18, the beveled end portion 46 clears the first edge 80 of slot 26. It is to be appreciated that due to the bilateral symmetry of clip 30, it is possible to insert end 54 first into perch 14B to install clip 30.

Once clip 30 is initially positioned as shown in FIG. 5, a sufficient level of force applied to second end 54 of clip 30 will cause clip 30 to deform temporarily and sufficiently to become fully seated between top wall 24 and axle 18, as shown in FIG. 6. At this point, the first portion 64 of lower edge 62 engages the top of axle 18 and the top wall 40 of clip 30 engages the inner surface of the top wall 24 of perch 14B. In addition, tab 50 comes to rest between first and second edges 80, 82 of the first portion 26A of slot 26. Central portion 56 projects from top wall 40 such that raised tab 50 will not slide past slot edges 80 and 82 without a sufficient amount of lateral force. The lateral movement of clip 30 within the perch 14B is thus impeded by contact between ramped portions 58, 60 of tab 50 and edges 80 or 82 of slot 26.

The seated clip 30 can be easily removed from perch 14B by applying a sufficient amount of force to either end 52 or 54 of clip 30 to drive ramped portion 58 or 60 beneath the adjacent edge 80 or 82 of slot 26. In this manner, retainer clip 30 is configured to be easily removed from perch 14B and reused to enable the convenient replacement of rollers 16 (FIG. 2).

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific idler roll retainer clips discussed herein. Therefore, it is intended that this invention be limited only by the claims and the equivalents thereof.

What is claimed is:

1. An idler roller retainer clip comprising:
a generally U-shaped member having a first end and a second opposite end and comprising a base wall and opposing side walls extending from the base wall in a first direction, the base wall comprising an elevated tab extending from the base wall in a direction generally opposite the first direction, the side walls comprising an edge spaced from the base wall, the edge having a first portion, centered between the first and second ends, that is generally parallel to the base wall, the edge further having a second portion between the first portion and the respective first and second end of the U-shaped member, the second portion of the lower edge extending at an angle from the first portion toward the base wall.

2. The idler roll retainer clip of claim 1, wherein base wall further comprises a beveled end portion adjacent to each of the first and second ends of the generally U-shaped member.

3. The idler roller retainer clip of claim 1, wherein the elevated tab comprises a central portion spaced from the base wall and a pair of flanking ramped portions connected to each end of the central portion, each ramped portion further being connected to the base wall, the elevated tab having a length less than a distance between the first and second end of the generally U-shaped member.

4. The idler roll retainer clip of claim 3, wherein the elevated tab is centered relative to the first and second ends of the generally U-shaped member.

5. The idler roller retainer clip of claim 4, wherein the first portion of the edge of each side wall has a length greater than the length of the elevated tab.

6. The idler roll retainer clip of claim 1, wherein the opposing side walls extend from the base at a diverging angle relative to one another.
